(19) United States
(12) Patent Application Publication
(10) Pub. No.: US 2024/0035698 A1
(43) Pub. Date: Feb. 1, 2024

(54) ENVIRONMENT CONTROL SYSTEM, ENVIRONMENT CONTROL DEVICE, AND ENVIRONMENT CONTROL METHOD

(71) Applicant: Mitsubishi Electric Corporation, Tokyo (JP)

(72) Inventors: Seiro YUGE, Tokyo (JP); Kota KURIHARA, Tokyo (JP); Koji OTA, Tokyo (JP)

(73) Assignee: Mitsubishi Electric Corporation, Tokyo (JP)

(21) Appl. No.: 18/275,411

(22) PCT Filed: Mar. 10, 2021
(86) PCT No.: PCT/JP2021/009529

§ 371 Date: Aug. 2, 2023

(51) Int. Cl. F24F 11/63

(52) U.S. Cl. CPC F24F 11/63; F24F 2120/20

(57) ABSTRACT

An environment control system is provided with human-body sensor that obtains biological information that indicates a body condition of a user, an environment measurement device that measures an environmental parameter that indicates an environment state of a target space in which the user is present, an environment control device that adjusts the environment state of the target space, and an environment control device that controls the environment adjustment device and is provided with a converter that converts the biological information into a biological parameter, and a controller that determines control contents in accordance with which the environment adjustment device is controlled on the basis of the biological parameter and the environmental parameter and sends a control signal that indicates the determined control contents to the environment adjustment device. The environment adjustment device that operates in accordance with the received control signal.

### TECHNICAL FIELD

The present disclosure relates to an environment control system, an environment control device, and an environment control method each configured to adjust an environment state around a user and thus to improve the comfort level of the user.

### BACKGROUND ART

Some environment control device has been known that is configured to, by use of biological information that indicates body conditions of a person, such as a pulse wave, estimate a warm-cold sense of the person and control an environment state on the basis of estimation results. Such an environment control device is referable to, for example, Patent Literature 1. The environment control device described in Patent Literature 1 is configured to control devices such as an air-conditioning apparatus that provide a residential environment of a user on the basis of a warm-cold sense estimated by use of parameters obtained from measurement results of pulse waves.

### CITATION LIST

### Patent Literature

Patent Literature 1: International Publication No. 2007/007632

### SUMMARY OF INVENTION

### Technical Problem

Patent Literature 1 describes, as parameters used when a warm-cold sense of a person is estimated, fluctuation in maximum Lyapunov exponent, fluctuation in maximum value of a pulse-wave wave height, fluctuation in median value of a trajectory parallel measurement, and other factors. In the above description, such parameters such as the maximum Lyapunov exponent, the maximum value of a pulse-wave wave height, and the median value of a trajectory parallel measurement are obtained by analyzing data on pulse waves in time series for a certain period of time. A warm-cold sense is then estimated on the basis of temporal changes in such parameters such as the maximum Lyapunov exponent, the maximum value of a pulse-wave wave height, and the median value of a trajectory parallel measurement. To estimate a warm-cold sense to improve the comfort level of a user, data on pulse waves in time series for a certain period of time thus has to be collected and the amount of temporal change in such parameters such as the maximum Lyapunov exponent and the maximum value of a pulse-wave wave height thus also has to be calculated. Time thus may be required to estimate a warm-cold sense and, as a result, time may be required before control is started that improves the comfort level of a user on the basis of the warm-cold sense.

The present disclosure is made to solve the above problem and to provide an environment control system, an environment control device, and an environment control method each configured to promptly improve the comfort level of a user.

### Solution to Problem

An environment control system according to an embodiment of the present disclosure has a human-body sensor configured to obtain biological information that indicates a body condition of a user; an environment measurement device configured to measure a value of an environmental parameter that indicates an environment state of a target space in which the user is present; an environment adjustment device configured to adjust the environment state of the target space; and an environment control device configured to control the environment adjustment device, in which the environment control device is provided with a converter configured to convert the biological information into a value of a biological parameter, and a controller configured to determine a control content in accordance with which the environment adjustment device is controlled on the basis of the value of the biological parameter and the value of the environmental parameter and send a control signal that indicates the determined control content to the environment adjustment device, and the environment adjustment device is configured to receive the control signal and operate on the basis of the received control signal.

An environment control device according to another embodiment of the present disclosure is configured to control an environment adjustment device configured to adjust an environment state of a target space in which a user is present and is provided with a converter configured to obtain, from a human-body sensor configured to obtain biological information that indicates a body condition of the user, the biological information and convert the biological information into a value of a biological parameter; and a controller configured to obtain, from an environment measurement device configured to measure a value of an environmental parameter that indicates the environment state of the target space, the value of the environmental parameter, in which the controller is configured to determine a control content in accordance with which the environment adjustment device is controlled on the basis of the value of the biological parameter and the value of the environmental parameter, and to send a control signal that indicates the determined control content to the environment adjustment device.

An environment control method according to still another embodiment of the present disclosure is configured to control an environment state of a target space in which a user is present by use of an environment control system and includes obtaining biological information that indicates a body condition of the user; measuring a value of an environmental parameter that indicates the environment state; converting the biological information into a value of a biological parameter; and exercising control such that a control content is determined in accordance with which an environment adjustment device configured to adjust the environment state is controlled on the basis of the value of the biological parameter and the value of the environmental parameter and the environment adjustment device is controlled on the basis of the determined control content.

### Advantageous Effects of Invention

An environment control system, an environment control device, and an environment control method according to embodiments of the present disclosure each configured to determine control information on the basis of the value of an environmental parameter and the value of a biological parameter obtained from biological information and control an environment state on the basis of the control information. To determine the control information, data collection for a long period of time is thus no longer required. The environment control system is therefore configured to promptly control the environment state and improve the comfort level of a user.

### BRIEF DESCRIPTION OF DRAWINGS

FIG. 1 is a block diagram that illustrates an exemplary configuration of an environment control system according to Embodiment 1.

FIG. 2 is a flowchart that illustrates an exemplary flow of an environment control process performed by the environment control system according to Embodiment 1.

FIG. 3 is a block diagram that illustrates an exemplary configuration of an environment control system 200 according to Embodiment 2.

FIG. 4 is a flowchart that illustrates an exemplary flow of an environment control method performed by the environment control system according to Embodiment 2.

### DESCRIPTION OF EMBODIMENTS

An environment control system, an environment control device, and an environment control method according to embodiments are described below in detail with reference to drawings.

### Embodiment 1

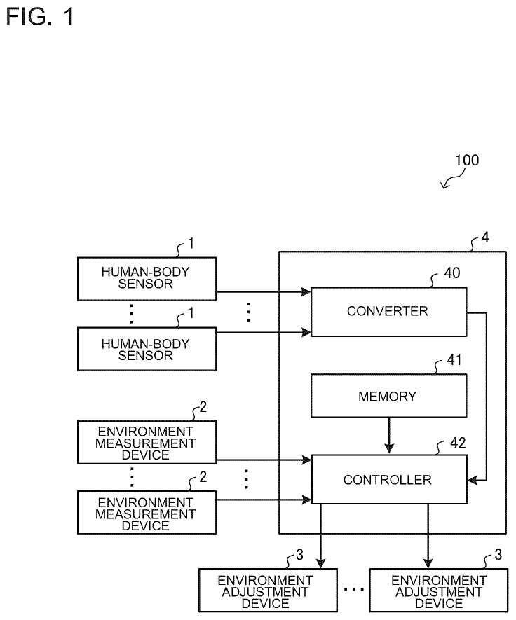

FIG. 1 is a block diagram that illustrates an exemplary configuration of an environment control system according to Embodiment 1. The environment control system 100 according to Embodiment 1 is configured to provide an environment state that is optimum possible for a user on the basis of a body condition of the user and an environment state around the user. The environment control system 100 has one or more human-body sensors 1, one or more environment measurement devices 2, one or more environment adjustment devices 3, and an environment control device 4.

The human-body sensors 1 are each configured to obtain biological information that indicates a body condition of a user from the user in a state in which the human-body sensor 1 is in contact with the user or is in contact without the user. The biological information is, for example, a pulse rate or information on skin temperature of a face, a hand, or another body part, the number of blinks, or body motion such as body sway.

The human-body sensor 1 is, for example, a fixed sensor installed in a room or a wearable sensor worn by a user. The fixed sensor in Embodiment 1 is an infrared radiation sensor configured to receive infrared rays and detect a temperature. The infrared radiation sensor is configured to change its direction in an up-down direction and a left-right direction by use of a motor such as a stepping motor. Such an infrared radiation sensor installed on a ceiling, a wall, or another location inside a room is thus configured to obtain biological information that indicates a body condition of a person who is present in the room and in an area that is scannable through drive of a motor without being in contact with the person. Such a fixed sensor and a wearable sensor are configured to obtain biological information without a load on a user. The human-body sensor 1 may also be a sensor provided with a camera and configured to recognize a face, an upper body, or another body part of a user.

The human-body sensor 1 is configured send obtained biological information to the environment control device 4. Since the environment control system 100 has the one or more human-body sensors 1, the environment control device 4 is configured to obtain one or more pieces of biological information from the one or more respective human-body sensors 1.

The environment measurement devices 2 are each configured to measure the value of a parameter that serves as an index that indicates an environment state around a user. The environment measurement device 2 is, for example, a thermometer, a hygrometer, an anemometer, an illuminometer, a color thermometer, or a noise meter. The parameter that indicates an environment state is, for example, air temperature, humidity, wind speed, illuminance, color temperature, or a noise level. In the following description, the parameter that indicates an environment state is referred to as an environmental parameter. The one or more environment measurement devices 2 are configured to send one or more respective measured values of environmental parameters to the environment control device 4.

The environment adjustment devices 3 are each configured to adjust at least one of air temperature, humidity, an air volume, a wind direction, light, illuminance, color temperature, sound, and a sound volume in a target space. The environment adjustment device 3 is, for example, an air-conditioning apparatus configured to adjust at least one of air temperature, humidity, an air volume, and a wind direction. Alternatively, the environment adjustment device 3 may also be a light control device such as a lighting apparatus configured to turn on and off a light. In a case in which the environment adjustment device 3 is a light control device, the environment adjustment device 3 may also be configured to adjust at least one of illuminance and color temperature. Alternatively, the environment adjustment device 3 may also be, for example, a sound control device such as an audio apparatus configured to produce sound and adjust a sound volume.

The environment control device 4 is configured to control the environment adjustment devices 3 on the basis of biological information and the value of an environmental parameter to improve the comfort level of a user. The environment control device 4 is provided with a converter 40, a memory 41, and a controller 42.

The converter 40 is configured to obtain one or more pieces of biological information from the one or more respective human-body sensors 1. The converter 40 is then configured to convert the one or more obtained pieces of biological information into one or more values of biological parameters, which are described below.

The biological parameter is a parameter that serves as an index that indicates a body condition of a person and correlates with the comfort level of the person. The biological parameter is, for example, the amount of change in skin temperature, the difference between skin temperatures, the amount of change in number of blinks, the amount of change in body motion, or the value of a heart rate variability parameter.

The amount of change in skin temperature is, for example, the difference in skin temperature before and after a predetermined period of time elapses, a time derivative of skin temperature, or the amount of change from predetermined reference skin temperature. The reference skin temperature is skin temperature observed in a case in which, for example, the comfort level of a user is high or a user is in a resting state. The reference skin temperature is obtained in advance. In the following description, the amount of change in skin temperature may also be described as a skin-temperature change amount.

The difference in skin temperature is a difference in surface temperature between two regions of a body, such as a difference in temperature between a face and a hand and a difference in temperature between a forehead and a cheek. The two regions are parts of which surface temperatures have a difference that is effectual to estimate the comfort level of a user. The two regions are predetermined. In the following description, the difference in skin temperature may also be described as a skin-temperature difference.

The amount of change in number of blinks is, for example, the difference in number of blinks before and after a predetermined period of time elapses, a time derivative of the number of blinks, or the amount of change from the predetermined reference number of blinks. The reference number of blinks is the number of blinks observed in a case in which, for example, the comfort level of a user is high or a user is in a resting state. The reference number of blinks is obtained in advance. In the following description, the amount of change in number of blinks may also be described as a number-of-blinks change amount.

The amount of change in body motion is, for example, the difference in, a time derivative of, or the amount of change from a predetermined reference value in, a factor such as the amplitude of body sway and the number of sway actions for a unit time, before and after a predetermined period of time elapses. The reference value is, for example, the amplitude of body sway or the number of sway actions for a unit time when a user is awake. The reference value is obtained in advance. In the following description, the amount of change in body motion may also be described as a body-motion change amount.

The heart rate variability parameter is, for example, a heart rate variability (HRV) or a standard deviation of the normal to normal interval (SDNN).

The converter 40 is configured to send, to the controller 42, one or more values of biological parameters obtained by converting one or more pieces of biological information.

The memory 41 is configured to store correlation information that indicates a correlation between one or more values of biological parameters and the comfort level of the person. The memory 41 is configured to store correlation information in which, for example, a skin-temperature change amount a [degrees C.] and the comfort level of a person who has the skin-temperature change amount a [degrees C.] are associated with each other. In Embodiment 1, the comfort level of a person is indicated by a numerical value.

The correlation information may also be one or more mathematical formulas by which one or more values of biological parameters and the comfort level of a person are related with each other. The correlation information may also be, for example, a combination of a mathematical formula that indicates a correlation between a skin-temperature change amount and a comfort level and a mathematical formula that indicates a correlation between a heart rate variability parameter and the comfort level. Alternatively, the correlation information may also be a mathematical formula that indicates a correlation between a comfort level and a combination of a skin-temperature change amount and a heart rate variability parameter. The correlation information may also be, for example, a database in tabular form in which one or more values of biological parameters and the comfort level of a person are related with each other. The correlation information may also be, for example, a combination of a database in tabular form in which the value of a skin-temperature change amount and a comfort level are related with each other and a database in tabular form in which the value of a heart rate variability parameter and a comfort level are related with each other. Alternatively, the correlation information may also be a database in tabular form in which the value of a comfort level and a combination of the value of a skin-temperature change amount and the value of a heart rate variability parameter are related with each other.

The memory 41 is configured to store information that indicates an instruction from the environment control device 4 to the environment adjustment devices 3. The memory 41 is configured to store information that indicates an instruction that, when the environment adjustment device 3 is, for example, an air-conditioning apparatus, air temperature is to rise or fall, humidity is to rise or fall, a wind direction is to change, or an air volume is to increase or decrease in a target space, or another instruction. The information stored in the memory 41 corresponds to information that indicates a change instruction in accordance with which values of set parameters of an air-conditioning apparatus such as set temperature, set humidity, a set wind direction, and a set air volume are changed. The memory 41 is configured to store information that indicates a change instruction that, when the environment adjustment device 3 is, for example, a light control device, a factor such as illuminance and color temperature is to change in a target space. The information stored in the memory 41 corresponds to information that indicates a change instruction in accordance with which values of set parameters that indicates a state in which the light control device is on or off or values of set parameters such as set illuminance and set color temperature are changed. The information that indicates an instruction from the environment control device 4 to the environment adjustment devices 3 and described above is information used to provide an environment state that is comfortable for a user and is also information that indicates a control direction from the environment control device 4 to the environment adjustment devices 3. In the following description, the information that indicates the control direction may also be described as control direction information.

The memory 41 is configured to store one or more biological parameters and a plurality of pieces of control direction information, which are associated with each other. When the environment adjustment device 3 is, for example, an air-conditioning apparatus, the memory 41 is configured to store at least one of a skin-temperature change amount and a skin-temperature difference and control direction information that indicates a change instruction that a factor such as air temperature, humidity, a wind direction, and an air volume is to change such that the at least one and the control direction information are associated with each other. In other words, the memory 41 is configured to store control direction information that indicates a control direction that is to improve a comfort level correlated with the values of biological parameters of a user such that the control direction information is associated with the biological parameters.

The controller 42 is configured to obtain one or more values of biological parameters from the converter 40 and obtain one or more values of environmental parameters from one or more environment measurement devices 2. The controller 42 is configured to select one or more pieces of control direction information that each indicate a control direction that is to increase the comfort level of a user to a comfort level that is set as a target from pieces of control direction information stored by the memory 41. In the following description, the comfort level that is set as a target is described as a target comfort level and the value of a biological parameter that is associated with the target comfort level in the memory 41 is described as a target value. The target comfort level or the target value may also be predetermined. Alternatively, the target comfort level or the target value may also be determined every time one or more pieces of biological information are measured and one or more values of biological parameters are calculated.

The controller 42 is configured to compute differences between one or more values of biological parameters obtained from the converter 40 and one or more target values for the biological parameters. In a case in which the controller 42 obtains two or more values of biological parameters from the converter 40, the controller 42 is configured to calculate the difference between each of the two or more values of biological parameters and the corresponding one of two or more target values for the biological parameters.

In a case in which a difference between the value of any one biological parameter of one or more biological parameters and the target value for the one biological parameter is higher than or equal to a threshold value, the controller 42 is configured to extract a piece of control direction information that is associated with the one biological parameter. Specifically, in a case in which the difference between a skin-temperature change amount obtained from the converter 40 and the target value for the skin-temperature change amount is higher than or equal to a threshold value, the controller 42 is configured to extract a piece of control direction information that is associated with the skin-temperature change amount and that indicates a change instruction that is to change, for example, air temperature or an air volume. Alternatively, in a case in which the difference between a number-of-blinks change amount obtained from the converter 40 and the target value for the number-of-blinks change amount is higher than or equal to a threshold value, the controller 42 is configured to extract a piece of control direction information that is associated with the number-of-blinks change amount and that indicates a change instruction that is to change, for example, illuminance or color temperature.

The controller 42 is configured to determine details of control contents on the basis of an extracted piece of control direction information and any of one or more values of environmental parameters. In other words, the controller 42 is configured to determine the value of the set parameter for the environment adjustment device 3 on the basis of an extracted piece of control direction information and any of one or more values of environmental parameters. Specifically, when the controller 42 selects a piece of control direction information that instructs an air-conditioning apparatus to change its set temperature, the controller 42 is configured to determine the set temperature on the basis of air temperature, humidity, or other factor obtained from an environment measurement device 2. Candidates for the set temperature in the air-conditioning apparatus are more than one. The controller 42 is thus configured to select any set temperature from a plurality of set temperatures on the basis of the value of an environmental parameter such as air temperature and humidity. When the controller 42 selects a piece of control direction information that instructs a light control device to change its set illuminance, the controller 42 is configured to determine the set illuminance on the basis of illuminance obtained from an environment measurement device 2. Candidates for the set illuminance in the light control device are more than one. The controller 42 is thus configured to select any set temperature from a plurality of set illuminances on the basis of illuminance obtained from an environment measurement device 2. In the following description, the value of set parameter such as set temperature, set humidity, a set air volume, a set wind direction, set illuminance, set color temperature, and a set sound volume may also be described as control detail information. Also, in the following description, information that includes control direction information and control detail information may also be described as control information. The control information is information that is to instruct an environment adjustment device 3 to operate on the basis of the value of determined set parameter and is also information that indicates control contents that are to control the environment adjustment device 3 by the environment control device 4.

The controller 42 may also be configured to determine control information not only as described above but also as described below. In this case, the memory 41 is configured to store in advance the value of an environmental parameter such as air temperature, humidity, an air volume, illuminance, and color temperature that a person feels comfortable. In the following description, the value of an environmental parameter with which a person feels comfortable may also be described as a comfort-environment value. In this case, the memory 41 is configured to store one or more environmental parameters, one or more biological parameters, and a plurality of pieces of control direction information, which are associated with each other. The memory 41 is configured to store environmental parameters such as air temperature, humidity, and an air volume, biological parameters such as a skin-temperature change amount and a skin-temperature difference, and pieces of control direction information that are to cause an air-conditioning apparatus to change its setting such as set temperature and set humidity such that the environmental parameters, the biological parameters, and the pieces of control direction information are associated with each other. In other words, the memory 41 is configured to store environmental parameters, which have effects on biological parameters that indicate a body condition of a user, the biological parameters, and pieces of control direction information that indicates a control direction that is to improve a comfort level correlated with the values of the biological parameters such that the environmental parameters, the biological parameters, and the pieces of control direction information are associated with each other.

In this case, when the controller 42 is to select pieces of control direction information, the controller 42 is configured to use differences between one or more values of environmental parameters obtained from an environment measurement device 2 and one or more comfort-environment values for the environmental parameters. Specifically, the controller 42 is configured to select, from pieces of control direction information stored in the memory 41, one or more pieces of control direction information that are associated with a biological parameter that has a difference from its target value by a value higher than or equal to its threshold value and that also are associated with an environmental parameter that has a difference from its comfort-environment value by a value higher than or equal to its threshold. The controller 42 is configured to determine a piece of control detail information on the basis of selected pieces of control direction information and any of one or more values of environmental parameters. Specifically, when the controller 42 determines that the set temperature of an air-conditioning apparatus is to be changed, the controller 42 is configured to determine the set temperature on the basis of air temperature. The controller 42 may also use a comfort-environment value as a piece of control detail information. In this case, the controller 42 may also be configured to determine a piece of control detail information on the basis of any one or more values of environmental parameters in a case in which comfort-environment values have some range. For example, in a case in which the comfort-environment value of air temperature is 20 [degrees C.] to 25 [degrees C.], any temperature within a range from 20 [degrees C.] to 25 [degrees C.] may be specified as set temperature for an air temperature on the basis of air temperature measured by an environment measurement device 2.

In a case in which a comfort level does not reach its target comfort level, the controller 42 may also be configured to select one piece of control direction information and may also be configured to select two pieces of control direction information. In a case in which the controller 42 selects one piece of control direction information, the controller 42 may also be configured to select a piece of control direction information in accordance with which the rate of increase in comfort level is the highest possible. A method by which the controller 42 selects a pieces of control direction information is not limited to the method described above.

The controller 42 is configured to control one or more environment adjustment devices 3 in accordance with one or more determined pieces of control information. The number of pieces of control information is the same as the number of pieces of control direction information. The controller 42 is configured to send one or more control signals that indicate the one or more pieces of control information to one or more environment adjustment devices 3 that are control targets. The environment adjustment devices 3, which receive the control signals, operate in accordance with the control signals. Specific description is provided below.

In a case in which determined piece of control information is to instruct change in set temperature or set humidity, the controller 42 is configured to send a control signal that indicates the piece of control information to air-conditioning apparatuses installed within an area defined by a distance predetermined by a user and cause the air-conditioning apparatuses to change their set temperatures or set humidities. In a case in which determined piece of control information is to instruct change in a wind direction or an air volume, to control wind against a user, the controller 42 is configured to send a control signal that indicates the piece of control information to air-conditioning apparatuses installed within an area defined by a distance predetermined by a user and, for example, cause the air-conditioning apparatuses that each have a louver at its air outlet to each change the direction in which the louver faces. In a case in which determined piece of control information is to instruct, for example, sound production or sound volume adjustment, the controller 42 is configured to send a control signal that indicates the piece of control information to sound control devices in a target space and cause the sound control devices to, for example, produce sound or adjust a sound volume. The sound production described above is, for example, providing music for relaxation or for improvement in concentration or providing an alarm tone or alarm sound. In a case in which determined piece of control information is to instruct a light to be turned on, the controller 42 is configured to send a control signal that indicates the piece of control information to light control devices in a target space and cause the light control devices to turn on the lights. In a case in which determined piece of control information is to instruct change in illuminance to a certain level, the controller 42 is configured to send a control signal that indicates the piece of control information to light control devices in a target space and cause the light control devices to change their illuminance to the certain level indicate by the piece of control information.

A hardware configuration of the environment control device 4 according to embodiments is described below. The environment control device 4 may be formed by, for example, a processor such as a central processing unit (CPU) and a micro processing unit (MPU), a memory such as a read only memory (ROM) and a random access memory (RAM), a storage device such as a hard disk drive (HDD) and a removable disk, or a circuit such as an input interface circuit and an output interface circuit. Selection of a piece of control information by the controller 42 and conversion of a piece of biological information by the converter 40 may be achieved by a processor when the processor reads out and executes various programs such as an environment control program stored in a memory. Obtainment of a piece of biological information from the human-body sensors 1 by the converter 40 may be achieved by an input interface circuit. Storage by the memory 41 may be achieved by a storage device. Transmission of control signals to the environment adjustment devices 3 by the controller 42 may be achieved by an output interface circuit. A whole or a part of functions of the environment control device 4 may also be achieved by a dedicated hardware device.

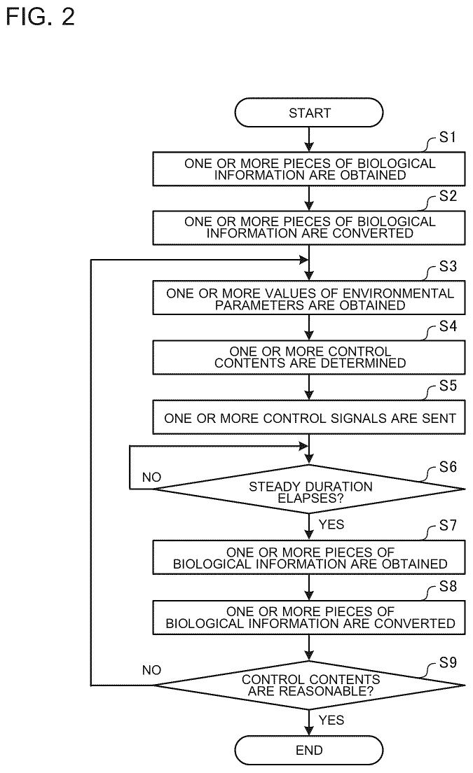

FIG. 2 is a flowchart that illustrates an exemplary flow of an environment control process performed by the environment control system according to Embodiment 1. In step S1, the converter 40 obtains one or more pieces of biological information obtained by one or more human-body sensors 1 from the one or more human-body sensors 1. In step S2, the converter 40 converts the one or more pieces of biological information into one or more values of biological parameters. The controller 42 obtains the one or more values of biological parameters from the converter 40.

In step S3, the controller 42 obtains one or more values of environmental parameters measured by one or more environment measurement devices 2 from the one or more environment measurement devices 2. The processes in step S1 and step S2 and the process in step S3 may also be performed simultaneously parallelly to each other or may alternatively be performed in reverse order.

In step S4, the controller 42 determines one or more control contents in accordance with which one or more environment adjustment devices 3 are controlled on the basis of one or more values of biological parameters obtained from the converter 40 and one or more values of environmental parameters obtained from one or more environment measurement devices 2. In step S5, the controller 42 sends one or more control signals that indicate the one or more control contents to one or more environment adjustment devices 3 that are control targets. The environment adjustment devices 3 that receive the control signals operate in accordance with the control signals.

The environment control system 100 according to Embodiment 1 may finish the environment control process after step S5 and may alternatively continue to processes in step S6 and later steps, which are described below. In step S6, the controller 42 judges whether predetermined steady duration elapses. Steady duration is a state in which environment control is executed and an environment state thus does not change or a state in which environment control is executed and the amount of change from the current environmental parameter is thus lower than or equal to a threshold value. During a time before the steady duration does not elapse, which is indicated by NO in step S6, the environment control device 4 stops the process at step S6 and the environment adjustment devices 3, which operate in accordance with control signals, continue to operate in accordance with the control signals.

In a case in which the steady duration elapses in step S6, which is indicated by YES in step S6, the converter 40 obtains one or more pieces of biological information obtained by one or more human-body sensors 1 from the one or more human-body sensors 1 in step S7. In step S8, the converter 40 converts the one or more pieces of biological information into one or more values of biological parameters. The controller 42 obtains the one or more values of biological parameters from the converter 40.

In step S9, the controller 42 judges whether current control contents are reasonable on the basis of one or more values of biological parameters obtained in step S8 and associated comfort levels in correlation information. Specifically, the controller 42 judges whether the comfort levels are each higher than or equal to the corresponding one of target comfort levels. Alternatively, the controller 42 judges whether one or more values of biological parameters obtained in step S8 each equal the corresponding one of target values.

In a case in which the controller 42 judges that the current control contents are not reasonable, which is indicated by NO in step S9, the controller 42 proceeds to step S3. In step S4 followed by step S3 after step S9, the controller 42 may also select a control content other than one or more control contents determined in previous step S4. Specifically, the controller 42 may also select a piece of control direction information other than one or more pieces of control direction information selected in previous step S4 and may alternatively change a piece of control detail information determined in previous step S4. The controller 42 may also select, together with one or more control contents selected in previous step S4, a control content other than the one or more control contents selected in previous step S4. Specifically, the controller 42 may also select, together with one or more pieces of control direction information selected in previous step S4, a piece of control direction information other than the one or more pieces of control direction information selected in previous step S4. In step S9, in a case in which the controller 42 judges that the current control contents are reasonable, which is indicated by YES in step S9, the environment control system 100 finishes the environment control process.

In step S9, the controller 42 may also store, in the memory 41, one or more pieces of control information that indicate one or more control contents determined in step S4 and one or more values of biological parameters obtained in step S8 such that the one or more pieces of control information and the one or more values of biological parameters are correlated with each other. In other words, the controller 42 may also cumulatively store, in the memory 41, one or more pieces of control information determined every time the process in step S4 is executed and one or more values of biological parameters obtained in step S8 every time the process in step S4 is executed such that the one or more pieces of control information and the one or more values of biological parameters are correlated with each other. The controller 42 is thus configured to comprehend which piece of control information most promptly improves a comfort level by use of differences between one or more values of biological parameters obtained in step S8 every time one or more pieces of control information are determined in step S4 and the one or more target values for the biological parameters. The environment control device 4 is thus configured, at the next environment control process, to promptly set determination to one or more control contents that have, for example, an increase degree at which a comfort level most highly increases.

In step S9, the controller 42 may also store, in the memory 41, one or more pieces of control information determined in step S4 and one or more amounts of change in biological parameters such that the one or more pieces of control information and the one or more amounts of change in biological parameters are correlated with each other. In a case in which procedure has returned from step S9 to step S3 one or more times, one or more amounts of change in biological parameters are differences between one or more values of biological parameters obtained by the controller 42 in current step S8 and one or more values of biological parameters obtained by the controller 42 in previous step S8. In addition, in a case in which procedure has not returned from step S9 to step S3 even once, one or more amounts of change in biological parameters are differences between one or more values of biological parameters obtained by the controller 42 in step S8 and one or more values of biological parameters obtained by the controller 42 in step S3. The controller 42 is configured to comprehend how the one or more values of biological parameters and a comfort level have changed in accordance with determined one or more control contents by storing, in the memory 41, one or more pieces of control information determined in step S4 and the differences described above such that the one or more pieces of control information and the differences are correlated with each other. The environment control device 4 is thus configured, at the next environment control process, to promptly set determination to one or more control contents that have, for example, an increase degree at which a comfort level most highly increases.

In a case in which one user is present in a target space of which environment is to be controlled, the environment control system 100 may also perform an environment control process in which the comfort level of the one user is increased. Alternatively, in a case in which a plurality of users are present in the target space, the environment control system 100 may also perform an environment control process in which the comfort levels of the plurality of users are increased and may also exercise control in which the comfort level of at least one of the plurality of users is increased. In a case in which control is to be exercised such that at least one of the plurality of users has an improved comfort level, the environment control system 100 may be configured to select the at least one through face authentication by use of a camera and may also be configured to select the at least one by use of identifiers (ID) of terminals of the plurality of respective users. In a case in which control is to be exercised such that the plurality of users have improved comfort levels, the environment control system 100 may also perform processes described below. One or more human-body sensors 1 in the environment control system 100 obtain a plurality of pieces of biological information from the plurality of users and the converter 40 obtains a plurality of values of biological parameters from the plurality of pieces of biological information. The controller 42 assigns, to a group, pieces of information that indicate two or more users whose two or more pieces of biological information are sources of two or more values of biological parameters, among the plurality of values of biological parameters described above, that have a difference from each other that is lower than or equal to a threshold value. The information that indicates a user may be, for example, information in accordance with which the user is recognized through the face authentication and may also be a terminal ID of the user. Instead of the processes of group assignment described above, the controller 42 may also assigns, to a group, pieces of information that indicate the two or more users whose two or more pieces of biological information are sources of two or more values of biological parameters that have respective values of differences each from a target value that are close to each other. The two or more values of biological parameters that have respective values of differences each from a target value that are close to each other are values of differences each from the target value that have a difference from each other that is lower than or equal to a threshold value. The threshold value is obtained in advance through experimentation or other procedure. The controller 42 determines a piece of control information to exercise control in accordance with the same control direction to the grouped two or more users. The controller 42 then controls the environment adjustment devices 3 in accordance with the determined control information. The positions of the grouped two or more users may be detected through face authentication by use of a camera and may also be detected on the basis of the radio field intensities of the terminals of the grouped two or more users.

Advantageous effects produced by the environment control system 100 according to Embodiment 1 are described below. The environment control system 100 according to Embodiment 1 has the human-body sensors 1, the environment measurement devices 2, the environment adjustment devices 3, and the environment control device 4. The human-body sensors 1 are each configured to obtain biological information that indicates a body condition of a user. The environment adjustment devices 3 are each configured to measure the value of an environmental parameter that indicates an environment state of a target space in which a user is present. The environment adjustment devices 3 are each configured to adjust the environment state of the target space. The environment control device 4 is configured to control the environment adjustment devices 3 and is provided with the converter 40 and the controller 42. The converter 40 is configured to convert a piece of biological information into the value of a biological parameter. The controller 42 is configured to determine control contents in accordance with which the environment adjustment devices 3 are controlled on the basis of the values of biological parameters and the values of environmental parameters. The controller 42 is then configured to send control signals that indicate the determined control contents to the environment adjustment devices 3. The environment adjustment devices 3 are configured to operate in accordance with the received control signals. With this configuration, the environment control system 100 does not have to continue obtaining biological information for a long period of time to determine control contents in accordance with which the environment adjustment devices 3 are controlled. The environment control system 100 is thus configured to promptly determine control contents in accordance with which the environment adjustment devices 3 are controlled and is therefore configured to promptly achieve a comfortable environment for a user.

The controller 42 according to Embodiment 1 is configured to determine control contents in accordance with which the environment adjustment devices 3 are controlled by selecting control contents among a plurality of control contents in accordance with which the environment adjustment devices 3 are controlled on the basis of the values of biological parameters and the values of environmental parameters. A plurality of control contents in accordance with which the environment adjustment devices 3 are controlled are determined in advance and the controller 42 is configured to select control contents among the plurality of control contents, and the environment control system 100 is therefore configured to further promptly achieve a comfortable environment for a user.

The controller 42 according to Embodiment 1 is configured to determine a control direction of how the environment adjustment devices 3 are to be controlled on the basis of the values of biological parameters. The controller 42 is then configured to determine the values of set parameters for the environment adjustment devices 3 on the basis of the determined control direction and the values of environmental parameters. The controller 42 is configured to send control signals that indicate the determined control direction and the values of set parameters to the environment adjustment devices 3. The environment control system 100 is configured to control the environment adjustment devices 3 by use of the control signals that indicate the control direction determined on the basis of the values of biological parameters and the values of set parameters determined on the basis of the values of environmental parameters and thus configured to exercise environment control that suits a body condition of a user and an environment state. The environment control system 100 is therefore configured to highly accurately improve the comfort level of a user.

The environment control device 4 according to Embodiment 1 is further provided with the memory 41 configured to store pieces of control direction information that indicate a plurality of respective control directions in accordance with which the environment adjustment devices 3 are controlled. The controller 42 is configured to select any piece of control direction information from the plurality of pieces of control direction information stored in the memory 41 on the basis of the values of biological parameters. The controller 42 is then configured to send control signals that indicate the selected piece of control direction information and the determined values of set parameters to the environment adjustment devices 3. The controller 42 is thus configured to promptly determine a control direction. The environment control system 100 is therefore configured to promptly improve the comfort level of a user.

The controller 42 according to Embodiment 1 is configured to determine a control direction of how the environment adjustment devices 3 are to be controlled on the basis of the values of biological parameters and the values of environmental parameters. The controller 42 is configured to determine the values of set parameters for the environment adjustment devices 3 on the basis of the determined control direction and the values of environmental parameters. The controller 42 is configured to send control signals that indicate the determined control direction and the values of set parameters to the environment adjustment devices 3. The environment control system 100 is configured to control the environment adjustment devices 3 by use of the control signals that indicate the control direction determined on the basis of both the values of biological parameters and the values of environmental parameters and the values of set parameters determined on the basis of the values of environmental parameters and thus configured to exercise environment control that suits a body condition of a user and an environment state. The environment control system 100 is therefore configured to highly accurately improve the comfort level of a user.

The environment control device 4 according to Embodiment 1 is further provided with the memory 41 configured to store pieces of control direction information that indicate a plurality of respective control directions in accordance with which the environment adjustment devices 3 are controlled. The controller 42 is configured to select any piece of control direction information from the plurality of pieces of control direction information stored in the memory 41 on the basis of the values of biological parameters and the values of environmental parameters. The controller 42 is then configured to send control signals that indicate the selected piece of control direction information and the determined values of set parameters to the environment adjustment devices 3. The controller 42 is thus configured to promptly determine a control direction. The environment control system 100 is therefore configured to promptly improve the comfort level of a user.

The environment adjustment devices 3 according to Embodiment 1 are each an air-conditioning apparatus configured to control at least one of air temperature, humidity, an air volume, and a wind direction in a target space. The environment control system 100 is therefore configured to improve a comfort level on the basis of a warm-cold sense of a user.

The environment adjustment devices 3 according to Embodiment 1 are each a light control device configured to control light in a target space. The environment control system 100 is therefore configured to improve the comfort level of a user through illuminance, color temperature, and other factor in the target space.

The environment adjustment devices 3 according to Embodiment 1 are each a sound control device configured to control sound in a target space. The environment control system 100 is thus configured to perform some operation such as noise level reduction and music provision with which a comfort level is to be improved and therefore configured to expand capability for improving the comfort level of a user through sound.

### Embodiment 2

An environment control system 200 according to Embodiment 2 is configured to prompt a user to take an action to improve a comfort level. Embodiment 2 is described below. To components in Embodiment 2 that are the same as components in Embodiment 1 described above, the same reference signs are provided. In addition, a configuration, a function, and other item in Embodiment 2 that are the same as a configuration, a function, and other item in Embodiment 1 are not described below unless otherwise required.

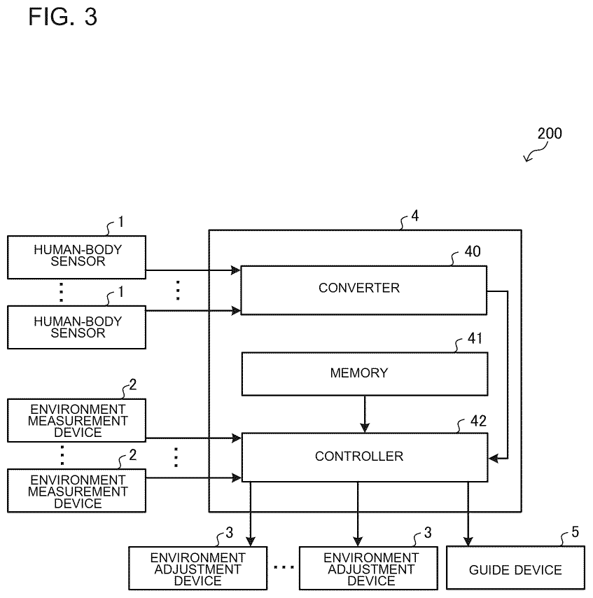

FIG. 3 is a block diagram that illustrates an exemplary configuration of the environment control system 200 according to Embodiment 2. In addition to components included in the environment control system 100 according to Embodiment 1 described above, the environment control system 200 is further provided with a guide device 5.

The guide device 5 is configured to prompt a user to take an action to improve a comfort level and reduce a discomfort level. The guide device 5 is, for example, a terminal device, an illumination device, a sound production device, or a display device. The terminal device is, for example, a personal computer (PC), a smartphone, or a tablet terminal. The illumination device includes one or more illumination tools. The sound production device is, for example, a speaker. The display device is, for example, a liquid crystal display or a cathode ray tube (CRT). The guide device 5 is configured to prompt a user to take an action such as a move to another location, a return home, an exercise, and taking a rest in accordance with an instruction from the controller 42.

In a case in which the guide device 5 is a terminal device, the environment control device 4 causes the terminal device to display guidance information or produce sound that provides the guidance information. The environment control device 4 may also cause the terminal device to provide the guidance information by producing an alarm tone. The guidance information is information by which a user is prompted to take an action. In a case in which the guide device 5 is an illumination device, the environment control device 4 causes the illumination device to provide guidance for a user by performing operation such as blinking light, turning on a specific illumination tool, changing illuminance, and changing color temperature. In a case in which the guide device 5 is a sound production device, the environment control device 4 causes the sound production device to produce sound that provides guidance information or produce an alarm tone. In a case in which the guide device 5 is a display device, the environment control device 4 causes the display device to display guidance information, present a visual in specific color, or display an image.

The controller 42 is configured to determine whether a user is to be guided. In a case in which the controller 42 determines that guidance is to be provided to a user, the controller 42 is configured to send, to the guide device 5, a guidance signal that is to instruct the guide device 5 to provide guidance to a user. The guide device 5 is configured to provide guidance to a user in accordance with the received guidance signal.

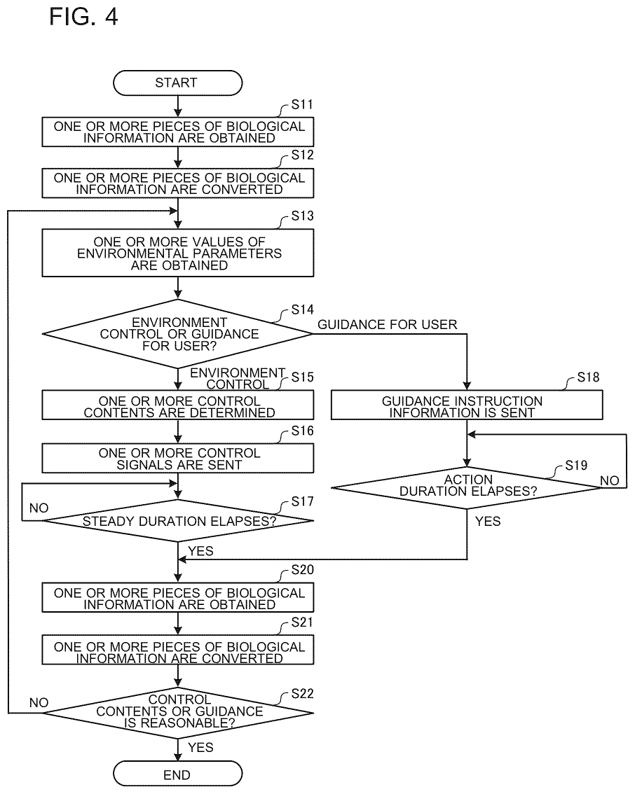

FIG. 4 is a flowchart that illustrates an exemplary flow of an environment control method performed by the environment control system according to Embodiment 2. The processes in step S11 to step S13 are the same as the processes in step S1 to step S3 and are thus not described below. In step S14, the controller 42 determines whether an environment state is to be controlled or whether a user is to be guided. The controller 42 determines that a user is to be guided in such a case in which a judgement is made that the comfort level of the user is not likely to improve even when, for example, an environment state is adjusted by all the environment adjustment devices 3 in the environment control system 200. Alternatively, the controller 42 determines that a user is to be guided in a case in which a judgement is made that the comfort level of the user is likely to further improve in a case in which, for example, the user moves to another location compared with a case in which the environment adjustment devices 3 start operation or change operation. Alternatively, the controller 42 determines that a user is to be guided in a case in which a judgement is made that the comfort level of the user is likely to further improve and electric power is likely to be further saved in a case in which, for example, the user moves to another location compared with a case in which the environment adjustment devices 3 start operation or change operation.

One or more values of biological parameters specified in a case in which the comfort level of a user does not improve even when all the environment adjustment devices 3 operate are stored in the memory 41. In the following description, the values of one or more biological parameters may also be each described as a guidance-necessity value. One or more guidance-necessity values of biological parameters are obtained in advance through experimentation or other procedure. In a case in which all or some of one or more values of biological parameters obtained from the converter 40 are guidance-necessity values, the controller 42 determines that guidance is to be provided to a user such as an exercise, a rest, an exit from a room. In a case in which one or more values of biological parameters obtained from the converter 40 are not guidance-necessity values, the controller 42 determines whether an environment state is to be controlled or whether a user is to be guided on the basis of the one or more values of biological parameters and one or more values of environmental parameters obtained from the environment measurement devices 2.

In step S14, in a case in which the controller 42 determines that an environment state is to be controlled, which is indicated by ENVIRONMENT CONTROL in step S14, the controller 42 transfers the process to step S15. The process in step 15 is the same as the process in step S4 and is thus not described below. After the process in step S15, the controller 42 transfers the process to step S16. The process in step S16 is the same as the process in step S5 and is thus not described below. After the process in step S16, the controller 42 transfers the process to step S17. The process in step S17 is the same as the process in step S6 and is thus not described below.

In step S14, in a case in which the controller 42 determines that guidance is to be provided to a user, which is indicated by GUIDANCE FOR USER in step S14, the controller 42 sends, to the guide device 5, a guidance signal that is to instruct the guide device 5 to provide guidance to a user in step S18. In a case in which the guide device 5 receives a guidance signal, the guide device 5 provides guidance to a user in accordance with the guidance signal. In step S19, the controller 42 judges whether action duration elapses. Action duration is a period of time required for a user to take an action such as a rest, an exercise, a move in a target space, and an exit from a room and is determined in advance through experimentation or other procedure.

During a time before the action duration does not elapse in step S19, which is indicated by NO in step S19, the controller 42 returns the process to step S19. In a case in which the action duration elapses in step S19, which is indicated by YES in step S19, the controller 42 transfers the process to step S20. In a case in which a user exits from a room before the action duration does not elapse in step S19, after step S19, the environment control system 200 finishes the environment control process. In a case in which a user is present in a target space after the action duration elapses in step S19, the environment control system 200 executes the process in step S20. The processes in step S20 and step S21 are the same as the processes in step S7 and step S8 and are thus not described below.

In step S22, the controller 42 judges whether one or more control contents determined in step S15 are reasonable or whether guidance provided in step S18 is reasonable. A judgement process in step S22 in which whether one or more control contents determined in step S15 are reasonable is the same as a process in step S9. The judgement in step S22 on whether guidance provided in step S18 is reasonable is made by judging whether the values of one or more biological parameters obtained by the controller 42 from the converter 40 in step S21 is equal to target values or whether a comfort level associated with the values of the one or more biological parameters on correlation information is higher than or equal to a target comfort level. In step S22, in a case in which one or more control contents determined in step S15 are reasonable or guidance provided in step S18 is reasonable, which is indicated in YES in step S22, the environment control system 200 finishes the environment control process. In step S22, in a case in which one or more control contents determined in step S15 are not reasonable or guidance provided in step S18 is not reasonable, which is indicated in NO in step S22, the controller 42 returns the process to step S13.

In step S22, the controller 42 may also store, in the memory 41, information that indicates guidance for a user determined in step S14 and one or more values of biological parameters obtained in step S21 such that the information and the one or more values of biological parameters are correlated with each other. In other words, the controller 42 may also cumulatively store, in the memory 41, information that indicates guidance determined every time the process in step S14 is executed and one or more values of biological parameters obtained in step S21 every time the process in step S14 is executed such that the information and the one or more values of biological parameters are correlated with each other. The controller 42 is thus configured to comprehend what guidance is likely to most promptly improve a comfort level by use of differences between the values of biological parameters obtained in step S20 every time guidance is determined to be executed in step S14 and one or more target values for the biological parameters. The environment control device 4 is thus configured, in step S14 at the next environment control process, to provide guidance that has, for example, an increase degree at which a comfort level most highly increases and thus promptly improve the comfort level of a user.

In a case in which one user is present in a target space, the environment control system 200 may also be configured to provide guidance to the one user. Alternatively, in a case in which a plurality of users are present in the target space, the environment control system 200 may also be configured to provide guidance to one or more users among the plurality of users. In a case in which guidance is to be provided to the one or more users, the environment control system 200 may also perform processes described below. One or more human-body sensors 1 in the environment control system 200 are configured to obtain a plurality of pieces of biological information from the plurality of users and the converter 40 is configured to obtain a plurality of values of biological parameters from the plurality of pieces of biological information. In a case in which one or more values of biological parameters among the plurality of values of biological parameters are each a guidance-necessity value, the controller 42 is configured to determine that guidance is to be provided to one or more users whose one or more pieces of biological information are sources of the one or more values of biological parameters. Alternatively, the controller 42 is configured to determine that guidance is to be provided to one or more users whose one or more pieces of biological information are sources of the one or more values of biological parameters on the basis of one or more values of biological parameters among the plurality of values of biological parameters and the values of environmental parameters. The positions of the one or more users may be detected through face authentication by use of a camera and may also be detected on the basis of radio field intensities of terminals of the one or more users. The controller 42 is configured to control the guide device 5 such that the guide device 5 provides guidance to the one or more users. In a case in which the guide device 5 is terminal devices assigned to respective users, the controller 42 may also be configured to cause the terminal devices of the one or more users to provide guidance.

Advantageous effects produced by the environment control system 200 according to Embodiment 2 are described below. The environment control system 200 according to Embodiment 2 further includes the guide device 5 configured to prompt a user to take a predetermined action. The controller 42 is configured to judge whether guidance that prompts a user to take the action is necessary on the basis of the values of biological parameters or the values of biological parameters and the values of environmental parameters. In a case in which the controller 42 judges that the guidance is necessary, the controller 42 is configured to send, to the guide device 5, a guidance signal that is to instruct the guide device 5 to provide guidance. In a case in which the guide device 5 receives the guidance signal, the guide device 5 is configured to provide guidance to a user in accordance with the guidance signal. In a case in which a comfort level improves by a user moving to another location or in a case in which the comfort level of a user does not improve even when an environment state is controlled, the environment control system 200 is therefore configured to expand capability for improving the comfort level of the user.

The guide device 5 is configured to provide guidance by use of at least one of light, sound, an image, and color. A user therefore easily notices the guidance and achieves an improved comfort level by taking an action in accordance with the guidance.

While embodiments are described above, contents of the present disclosure are not limited to the embodiments and include a range of conceivable equivalents.

### REFERENCE SIGNS LIST

1: human-body sensor, 2: environment measurement device, 3: environment adjustment device, 4: environment control device, 5: guide device, 40: converter, 41: memory, 42: controller, 100, 200: environment control system

1.-13. (canceled)

14. An environment control system comprising:
a human-body sensor configured to obtain biological information that indicates a body condition of a user;
an environment sensor configured to measure a value of an environmental parameter that indicates an environment state of a target space in which the user is present;
a plurality of environment adjusters each configured to adjust the environment state of the target space; and
environment control circuitry configured to control the plurality of environment adjusters,
the environment control circuitry being provided with
a converter configured to convert the biological information into a value of a biological parameter, and
control circuitry configured to determine a control direction that indicates how one of the plurality of environment adjusters is to be controlled on the basis of the value of the biological parameter, determine a value of a set parameter for the one of the plurality of environment adjusters on the basis of the determined control direction and the value of the environmental parameter, and send a control signal that indicates a control content that includes the value of the determined set parameter to the one of the plurality of environment adjusters,
the plurality of environment adjusters being each configured to receive the control signal and operate on the basis of the received control signal to improve a comfort level of the user,
in a case in which, when and after a predetermined steady duration elapses after the control circuitry sends the control signal, the value of the biological parameter based on the biological information obtained by the human-body sensor differs from a predetermined target value, the control circuitry being configured to redetermine a control direction in accordance with which the one of the plurality of environment adjusters is controlled on the basis of a value of the biological parameter newly obtained, redetermine a value of a set parameter for the one of the plurality of environment adjusters on the basis of the redetermined control direction and a value of the environmental parameter newly obtained, and send a control signal that indicates a control content that includes the value of the redetermined set parameter to the one of the plurality of environment adjusters.

15. The environment control system of claim 14, wherein the control circuitry is configured to determine the control direction that indicates how the one of the plurality of environment adjusters is to be controlled on the basis of the value of the biological parameter.

16. The environment control system of claim 15, wherein
the environment control circuitry is configured to store a plurality of pieces of control direction information that indicate a plurality of respective control directions in accordance with which the one of the plurality of environment adjusters is controlled, and
the control circuitry is configured
to select any piece of the control direction information from the plurality of pieces of the stored control direction information on the basis of the value of the biological parameter and the value of the environmental parameter, and
to send the control signal that indicates the selected piece of the control direction information and the determined value of the set parameter to the one of the plurality of environment adjusters.

17. The environment control system of claim 14, wherein
the environment control circuitry is configured to store a plurality of pieces of control direction information that indicate a plurality of respective control directions in accordance with which the one of the plurality of environment adjusters is controlled, and
the control circuitry is configured
to select any piece of the control direction information from the plurality of pieces of the stored control direction information on the basis of the value of the biological parameter, and
to send the control signal that indicates the selected piece of the control direction information and the determined value of the set parameter to the one of the plurality of environment adjusters.

18. The environment control system of claim 14, wherein the control circuitry is configured to determine the control content in accordance with which the one of the plurality of environment adjusters is controlled by selecting the control content among a plurality of control contents in accordance with which the one of the plurality of environment adjusters is controlled on the basis of the value of the biological parameter and the value of the environmental parameter.

19. The environment control system of claim 14, wherein at least one of the plurality of environment adjusters comprises an air-conditioning apparatus configured to control at least one of air temperature, humidity, an air volume, and a wind direction in the target space.

20. The environment control system of claim 14, wherein at least one of the plurality of environment adjusters comprises alight control device configured to control light in the target space.

21. The environment control system of claim 14, wherein at least one of the plurality of environment adjusters comprises a sound control device configured to control sound in the target space.

22. The environment control system of claim 14, further comprising a guide device configured to prompt the user to take a predetermined action, wherein
the control circuitry is configured
to judge whether guidance that prompts the user to take the predetermined action is necessary on the basis of the value of the biological parameter or the value of the biological parameter and the value of the environmental parameter, and
to send, to the guide device, a guidance signal that is to instruct the guide device to provide the guidance in a case in which the control circuitry judges that the guidance is necessary, and
in a case in which the guide device receives the guidance signal, the guide device is configured to provide the guidance to the user in accordance with the guidance signal.

23. The environment control system of claim 22, wherein the guide device is configured to provide the guidance by use of at least one of light, sound, an image, and color.

24. Environment control circuitry being configured to control a plurality of environment adjusters each configured to adjust an environment state of a target space in which a user is present, the environment control circuitry comprising:
a converter configured to obtain, from a human-body sensor configured to obtain biological information that indicates a body condition of the user, the biological information and convert the biological information into a value of a biological parameter; and
control circuitry configured to obtain, from an environment sensor configured to measure a value of an environmental parameter that indicates the environment state of the target space, the value of the environmental parameter,
the control circuitry being configured to determine a control direction that indicates how one of the plurality of environment adjusters is to be controlled on the basis of the value of the biological parameter, determine a value of a set parameter for the one of the plurality of environment adjusters on the basis of the determined control direction and the value of the environmental parameter, and send a control signal that indicates a control content that includes the value of the determined set parameter to the one of the plurality of environment adjusters,
in a case in which, when and after a predetermined steady duration elapses after the control circuitry sends the control signal, the value of the biological parameter based on the biological information obtained by the human-body sensor differs from a predetermined target value, the control circuitry being configured to redetermine a control direction in accordance with which the one of the plurality of environment adjusters is controlled on the basis of a value of the biological parameter newly obtained, redetermine a value of a set parameter for the one of the plurality of environment adjusters on the basis of the redetermined control direction and a value of the environmental parameter newly obtained, and send a control signal that indicates a control content that includes the value of the redetermined set parameter to the one of the plurality of environment adjusters.

25. An environment control method being configured to control an environment state of a target space in which a user is present by use of an environment control system, the environment control method comprising:
a biological-information obtainment step for obtaining biological information that indicates a body condition of the user;
an environment measurement step for measuring a value of an environmental parameter that indicates the environment state;
a conversion step for converting the biological information into a value of a biological parameter; and
a control step for determining a control direction that indicates how one of a plurality of environment adjusters each configured to adjust the environment state is to be controlled on the basis of the value of the biological parameter, determining a value of a set parameter for the one of the plurality of environment adjusters on the basis of the determined control direction and the value of the environmental parameter, and controlling the one of the plurality of environment adjusters on the basis of a control content that includes the value of the determined set parameter,
when and after a predetermined steady duration elapses after the control step is executed, the biological-information obtainment step, the conversion step, and the environment measurement step being re-executed,
the environment control method further comprising
a judgement step for judging whether the value of the biological parameter obtained in the re-executed biological-information obtainment step and the re-executed conversion step equals a predetermined target value,
the control step being re-executed in a case in which the value of the biological parameter is judged to differ from the predetermined target value in the judgement step,
in the re-executed control step, the one of the plurality of environment adjusters is controlled on the basis of a value of the biological parameter newly obtained and a value of the environmental parameter newly obtained.
